(19) United States
(12) Patent Application Publication
(10) Pub. No.: US 2025/0208862 A1
(43) Pub. Date: Jun. 26, 2025

(54) SYSTEM DEVELOPMENT INCORPORATING ETHICAL CONTEXT

(71) Applicant: International Business Machines Corporation, Armonk, NY (US)

(72) Inventors: Maja Vukovic, New York, NY (US); Kush Raj Varshney, Chappaqua, NY (US); Venkata Nagaraju Pavuluri, New Rochelle, NY (US); John Rofrano, Mahopac, NY (US)

(21) Appl. No.: 18/392,405

(22) Filed: Dec. 21, 2023

(51) Int. Cl. G06F 8/77

(52) U.S. Cl. CPC G06F 8/77

(57) ABSTRACT

Methods and systems for development pipeline generation include iteratively generating a development pipeline by determining an ethical concern relating to a development pipeline, identifying a constraint that mitigates the ethical concern, and adding the constraint to the development pipeline. The development pipeline is executed concurrent with the iteratively generating.

### BACKGROUND

The present invention generally relates to software and system development tools and, more particularly, to tools that automatically respond to ethical considerations.

DevOps is an approach to software development that incorporates a set of practices and tools to automate and systematize development and operations. A DevOps pipeline can help to automate the different stages of building and deploying a piece of software or other project, and a continuous integration/continuous delivery (CI/CD) framework in particular provides ongoing monitoring of the project to ensure that it continues to meet its objectives and requirements.

While DevOps seeks to improve the lifecycle of systems development, existing pipelines and tools fail to account for changing ethical considerations, both in the product that is being developed and in the pipeline itself. While certain goals may be stated during the formulation of a DevOps pipeline, the pipeline is insensitive to later-discovered ethical challenges without manual intervention. As a result, a DevOps pipeline may become outdated in the face of changing societal context, and may perpetuate unethical operations well past the point when the ethical concern was discovered.

### SUMMARY

A method for development pipeline generation includes iteratively generating a development pipeline by determining an ethical concern relating to a development pipeline, identifying a constraint that mitigates the ethical concern, and adding the constraint to the development pipeline. The development pipeline is executed concurrent with the iteratively generating.

A method for DevOps pipeline generation includes iteratively updating a DevOps pipeline script that includes instructions to build and deploy a machine learning model. The iterative update includes determining a new ethical concern relating to a bias in training data for the machine learning model that was not known at initial execution of the DevOps pipeline script, identifying a constraint that mitigates the new ethical concern, and adding the constraint as an entry in the DevOps pipeline script that performs a check to ensure the new ethical concern is not triggered. The updated DevOps pipeline script is executed concurrent with the iterative generating.

A system for development pipeline generation includes a hardware processor and a memory that stores a computer program. When executed by the hardware processor, the computer program causes the hardware processor to iteratively generate a development pipeline. The iterative generation includes determination of an ethical concern relating to a development pipeline, identification of a constraint that mitigates the ethical concern, and addition of the constraint to the development pipeline. The development pipeline is executed concurrent with the iterative generation.

A system for DevOps pipeline generation includes a hardware processor and a memory that stores a computer program. When executed by the hardware processor, the computer program causes the hardware processor to iteratively update a DevOps pipeline script that includes instructions to build and deploy a machine learning model and to execute the DevOps pipeline script concurrent with the iterative generation. The iterative generation includes determination of a new ethical concern relating to a bias in training data for the machine learning model that was not known at initial execution of the DevOps pipeline script, identification of a constraint that mitigates the new ethical concern, and addition of the constraint as an entry in the DevOps pipeline script that performs a check to ensure the new ethical concern is not triggered.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram of development pipeline generation, which iteratively identifies the intent for a given project and generates a pipeline responsive by performing actions dictated by the intent, in accordance with an embodiment of the present invention;

FIG. 2 is a block/flow diagram of a project governance method where changes to context are identified and used to determine misalignment between the pipeline's effects and the value that drive a project, in accordance with an embodiment of the present invention;

FIG. 3 is a diagram illustrating a machine learning training pipeline, where ethical concerns may be identified and mitigated at various stages, in accordance with an embodiment of the present invention;

FIG. 4 is an exemplary pipeline script that shows the inclusion of ethical checks that may be added responsive to the identification of an ethical concern, in accordance with an embodiment of the present invention;

FIG. 5 is a block/flow diagram of a method for generating and executing a pipeline in tandem, so that the pipeline can rapidly adapt to changes in the societal context, in accordance with an embodiment of the present invention; and

FIG. 6 is a block diagram of a computing system that can perform pipeline generation and execution, in accordance with an embodiment of the present invention.

### DETAILED DESCRIPTION

When developing software systems, DevOps continuous integration/continuous delivery (CI/CD) pipelines are often created in a semi-automated fashion, with manual oversight of the considerations that go into the operation of the pipelines. In such pipelines, ethical considerations and trust checks may be implemented as a separate process, such as in the certification of algorithms, and are not incorporated into the pipeline itself. Such semi-automated pipelines may be created from templates that include tools and steps needed to fulfill the requirements of building a system. The pipeline itself may be a set of automated process that integrate, build, and deploy code in a production environment.

However, ethical considerations may be built into the DevOps pipeline itself, with online feedback that adjusts the pipeline in response to contextual changes, such as new information being discovered that affects the ethical considerations underlying the pipeline's processes. Rather than simply imposing one or more new rules to check during the development process, the present embodiments may automatically make changes to the development process itself, and the corresponding tooling, to respond to changing conditions.

Methods and systems for development pipeline generation include iteratively generating a development pipeline by determining an ethical concern relating to a development pipeline, identifying a constraint that mitigates the ethical concern, and adding the constraint to the development pipeline. The development pipeline is executed concurrent with the iteratively generating. Incorporating ethical considerations makes it possible to automatically adapt the development pipeline to changing contexts.

In some cases, the development pipeline is a DevOps pipeline script and the constraint is an entry in the DevOps pipeline script that performs a check to ensure the ethical concern is not triggered. The use of a script and the addition of an entry to the script makes enables the automatic adaptation to changing contexts as new ethical concerns arise.

In some cases, the DevOps pipeline script further includes instructions to build and deploy a project. In the context of the full DevOps pipeline script, these instructions are performed within the constraints related to the ethical concern.

In some cases, determining the ethical concern includes a new ethical concern that was not known at initial execution of the development pipeline. The iterative process thereby reacts to changing context information by identifying and adapting to new ethical concerns.

In some cases, executing the development pipeline includes executing a new development pipeline responsive to adding the constraint for the new ethical concern. The use of the new development pipeline enacts the changes made to the development pipeline responsive to the new ethical concern.

In some cases, the development pipeline develops and deploys a machine learning model. The design and training of machine learning models is susceptible to ethical concerns at various stages, and the inclusion of ethical checks in the context of a machine learning development pipeline is particularly helpful to mitigate those concerns.

In some cases, the ethical concern is one of bias in training data for the machine learning model. The introduction of checks for bias in the training data helps to prevent training models that fail to account for differences in culture and appearance.

In some cases, the constraint includes bias mitigation during one of pre-processing, training, and post-processing. Bias mitigation techniques can be automatically introduced and applied to catch and correct bias in the development pipeline for the machine learning model.

In some cases, determining the ethical concern includes identifying changes in contextual information relating to the pipeline. These changes in contextual information can give rise to new ethical concerns and can reframe previously unseen issues as ethical concerns to be addressed.

In some cases, identifying the constraint includes looking up the ethical concern in a database to select a predetermined constraint associated with the ethical concern. A database of predetermined actions can be used to automatically respond to new ethical concerns and changing societal context.

A method for DevOps pipeline generation includes iteratively updating a DevOps pipeline script that includes instructions to build and deploy a machine learning model. The iterative update includes determining a new ethical concern relating to a bias in training data for the machine learning model that was not known at initial execution of the DevOps pipeline script, identifying a constraint that mitigates the new ethical concern, and adding the constraint as an entry in the DevOps pipeline script that performs a check to ensure the new ethical concern is not triggered. The updated DevOps pipeline script is executed concurrent with the iterative generating. Incorporating ethical considerations into a DevOps pipeline script makes it possible to automatically adapt the development pipeline to changing contexts for a machine learning model.

In some cases, the constraint includes bias mitigation during one of pre-processing, training, and post-processing. Bias mitigation techniques can be automatically introduced and applied to catch and correct bias in the development pipeline for the machine learning model.

In some cases, determining the ethical concern includes identifying changes in contextual information relating to the DevOps pipeline script. These changes in contextual information can give rise to new ethical concerns and can reframe previously unseen issues as ethical concerns to be addressed.

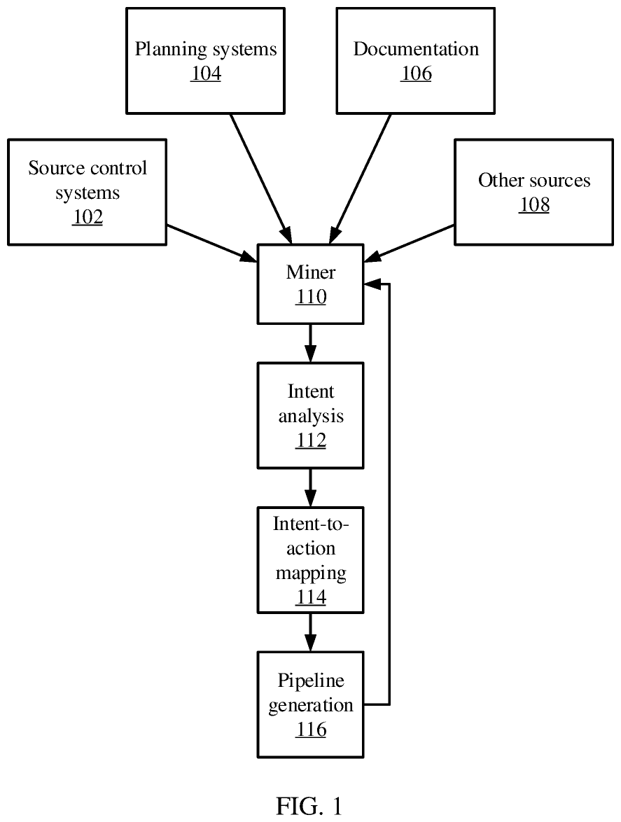

Referring now to FIG. 1, a method of pipeline generation for software/system development is shown. Information is drawn from a variety of sources, including source control systems 102, planning systems 104, documentation 106, and other sources 108, which may include varied textual and non-textual sources such as instant messages, meeting minutes and recordings, and software versioning system comments.

The various information sources are processed by miner 110. An intent analyzer 112 attempts to determine an intent for the pipeline based on the output of the miner 110, derived from the information sources. The miner 110 and the intent analyzer 112 elicit content to fill in a societal context representation, which can be used to gain situational awareness and context understanding in an automatic and systematized way. This information can be rendered in a machine-usable format for value alignment and pipeline generation.

An intent-to-action mapper 114 determines an action based on the intent analyzer, for example using a mapping database. A pipeline creator 116 then generates a pipeline for use in software/system development. This process may be repeated, with the pipeline creator 116 updating the pipeline responsive to new information from the information sources.

The societal context representation generated by the miner 110 and the intent analysis 112 may depend on a number of different precepts, such as values, biases, stereotypes, perceived needs, perceived problems, causal theories, and goals/strategies. The miner 110 identifies these precepts in its processing of the input information sources.

The precepts drive and constrain the behavior of agents, who in turn generate artifacts. In the context of software development, these precepts may be embodied in design documents and other types of planning or architecture that guides how an agent, the developer, goes about creating an artifact in the form of a software system. Precepts are known, predefined representations of the context. The miner 110 finds patterns in input information that match the precepts, such as biases and stereotypes. Thus the artifacts reflect and are influenced by the precepts.

Intent analysis 112 is performed based on the precepts identified by the miner 110. Intent analysis uses a domain model to express precepts as intents that can be addressed in the pipeline. For example, if a bias is identified, the corresponding intent may be bias mitigation to reduce the impact of the bias in the pipeline.

Intent-to-action mapping 114 maps the intents identified by intent analysis 112 to actions using a database of correspondences between known intents and actions. Following the example of bias mitigation as an intent, this may map to a specific bias mitigation algorithm that may be incorporated in the pipeline.

Pipeline creator 116 builds a pipeline to be used in developing and delivering a product, incorporating any steps or processes identified by the intent-to-action mapping 114. For example, the generated pipeline may include a series of steps or a script that identifies particular programs to run for building, testing, and deploying the product, as well as for compliance checks and ethical checks that are determined by the intent-to-action mapping 114.

During the use of a given pipeline, the societal context may change. For example, laws may change that necessitate alteration of the compliance checks in the pipeline. In addition, new information may be discovered regarding the ethical implications of parts of the pipeline. Societal context represents the present situation of the world, not just of the build process itself but third parties and environmental considerations that may be impacted by the build process. One example of societal context might be a financial loan approval application in the United states, where discrimination based on certain protected classes is illegal. Another example might be the discovery of an endangered species that is impacted in some way by the pipeline. As the context changes and is better understood, the process repeats to generate an updated pipeline that better accommodates the newly understood context.

This iterative process can be viewed as a control system that reacts to misalignments of values made apparent through testing as well as to a changing environment or context that can alter those values. These changes may include deliberation regarding the ethical principles to apply and may further include updating information relating to context. Thus, as new information is discovered that changes the ethical principles involved, or when the context changes the results of ethical considerations, the pipeline itself may be adapted to accommodate the new information.

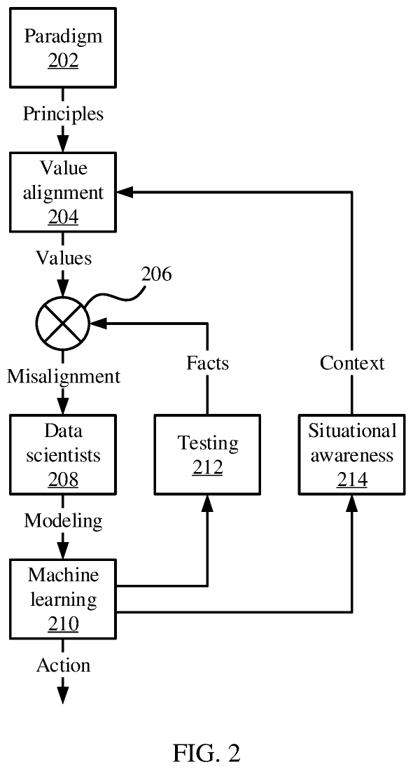

Referring now to FIG. 2, a method of value-sensitive pipeline governance is shown. Governance can be represented as a control system that reacts not only to misalignment of values apparent through testing and factsheets, but also to a changing environment or context that can alter the values being applied. Thus, a paradigm 202 is expressed as a set of principles that represent the goals of a project. These goals may include, for example, design goals, economic factors, and ethical considerations. These principles may be translated into a set of values at value alignment 204, which considers the principles in a particular societal context. The values may be represented as a structured ontology, where the relationships between relevant precepts are identified.

These values are compared 206 to facts known about the state of the project, and misalignments between the values and the facts may be identified. In some cases, these misalignments may reflect points where the present state of the project does not comply with one or more design requirements or legal requirements. In other cases, the misalignment may reflect a way in which the pipeline itself does not comport with the ethical principles guiding the project.

In monitoring the project, data scientists 208 identify information relating to this misalignment. For example, the misalignment may represent a shortfall in some metric that can be used in modeling the pipeline with a machine learning model 210. The machine learning model 210 may be trained to generate actions relating to the pipeline itself, for example altering compliance checks and ethical consideration algorithms to correct the misalignment. Testing 212 may then be performed on the pipeline in an ongoing fashion, identifying the facts that are used to determine whether future value misalignment occurs.

In addition, situational awareness 214 is introduced to capture changing information about societal context. As new contextual information is identified, the values generated by value alignment 204 from the guiding principles of the project may change as well. Thus, as a new ethical problem becomes apparent, the values may change accordingly and a new misalignment may be discovered. This causes a downstream change to the pipeline to correct the misalignment. As the iterative process continues, adaptations to changing circumstances can be automatically incorporated into the pipeline, and the project can continue in an ethical manner.

Identifying new contextual information may be based on a number of different sources. In some cases, the contextual information may derive from a changing regulatory landscape, as new laws and rules are passed and updated compliance checks are needed. In some cases, news information relating to a previously understood ethical problem may make it clear that the problem in fact applies to the project, so that updated ethical checks may be incorporated into the pipeline. In some cases, changing social mores may give rise to previously unexamined ethical inquiries, and the pipeline may further be adapted in response. This information may be derived from legislative changes and agency rulemaking, news sources, interviews with individuals, social media, and any other source of information about societal context.

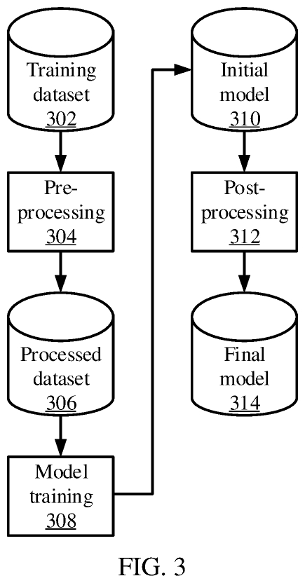

Referring now to FIG. 3, an exemplary pipeline is schematically shown. In one example, the pipeline may be directed to the generation of a machine learning model for a given task. The pipeline may begin with the input of a training dataset 302. The training dataset may include a set of examples and associated labels. In one specific example, the training dataset may include voice recordings and the labels may include the textual content of the voice recordings, including any additional semantic and syntactic tagging that may be needed for a task. Pre-processing 304 may be performed on the training dataset 302 to improve the quality of a processed dataset 306 for a particular task.

Model training 308 is used to generate an initial model 310. The model training may include, for example, iterating over a feed-forward and backpropagation process, where a classifier model is used to generate labels for training examples and the generated label is compared to the label in the training dataset. Model training alters parameters of the model at each iteration to improve the quality of the model's output until an initial model 310 is generated. Post-processing 312 may then be performed on the initial model to generate a final model 314 that is tuned for the given task.

At each stage, different actions may be taken to alter the pipeline. For example, during pre-processing 304, actions such as domain adaptation, bias mitigation, data sanitization, and representation disentanglement may be performed. During model training 308, actions may improve domain robustness, further mitigate bias, perform smoothing or adversarial training, and constrain the output to interpretable models. During post-processing 312, actions may include further bias mitigation, patching, providing post-hoc explanations, and performing a metamodel/infinitesimal jackknife. These various actions may serve different purposes, such as ensuring fairness, improving distributional robustness, improving robustness against adversaries, and quantifying uncertainty.

Following the example of a machine learning model that has the task of transcribing the content of a voice recording, one ethical consideration at play is to ensure that personal characteristics of the speaker do not affect the performance of the model. For example, pre-processing 304 may ensure that a representative distribution of languages, accents, and speech conditions is included to ensure that the model is capable of recognizing spoken words from a wide variety of backgrounds and cultures. Additional checks may be introduced into the pipeline to ensure that the model performs adequately in this respect, with failures of the model representing misalignments between the product and the project's values.

The feedback process may furthermore be responsive to new types of concern based on changing societal factors. For example, speech patterns may come into and out of fashion based on a wide variety of contextual factors. For example, face masks may muffle a speaker's voice and make it more difficult for a voice recognition model to accurately transcribe the content. While respiratory face masks may be easy to account for in a training dataset, culturally or religiously motivated face coverings may have different acoustic effects on the voice and representative training data be lacking. When this discrepancy is noticed, the new contextual information may be provided to bring the pipeline into line with the stated values of the project.

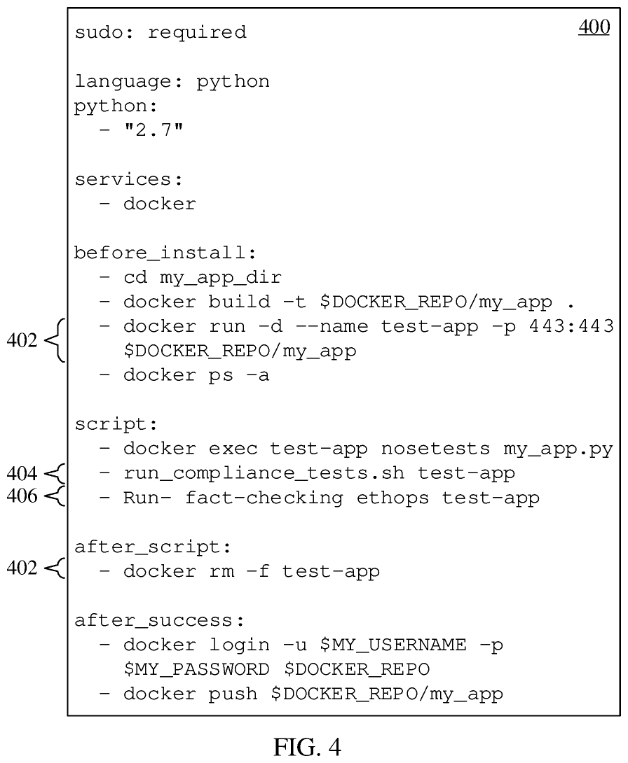

Referring now to FIG. 4, an exemplary pipeline script 400 is shown. The pipeline includes multiple sections, including sections relating to the build and deploying a project. Lines 402 relate to testing the project, and may include any tests appropriate to functionality. For example, in the case of a software product, the testing lines 402 may refer to scripts that ensure the project built correctly and that it produces the correct outputs.

Additional lines may include compliance checks 404. These compliance checks may reference additional tests to run to ensure compliance with statutory and regulatory requirements. Line 406 similarly calls an ethics check, and can include yet another set of tests to ensure that the pipeline performs its task in a manner that reflects the ever-changing social context and values.

These additions to the pipeline script 400 may be drawn from the intent-to-action mapping 114. For example, when a given ethical value is implicated by the intent analysis 112, the intent-to-action mapping can find one or more predetermined scripts to call in the pipeline to address the ethical concern.

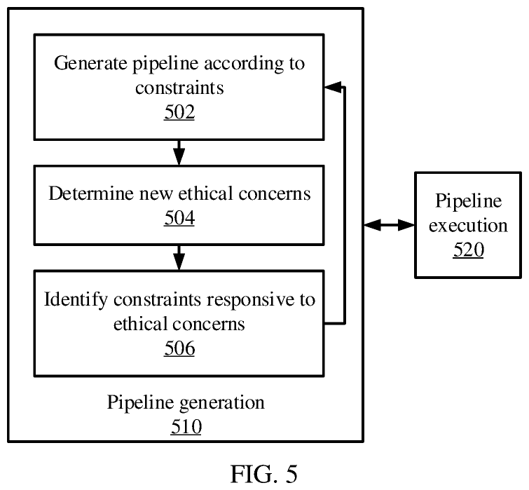

Referring now to FIG. 5, a method for generating and using a DevOps pipeline that includes ethical considerations is shown. Pipeline generation 510 includes the generation 502 of a pipeline according to initial constraints. As new information becomes available, new ethical concerns are determined 504. Constraints may be identified 506 that are responsive to the ethical concerns, and the process repeats with the generation 502 of a new pipeline according to the updated constraints. As used herein, the term constraint refers to material that is added to the pipeline to ensure compliance and to check ethical concerns, mitigating the issue. This procedure may be extended to reflect any new constraints that are introduced, such as changes to the regulatory landscape.

In some cases, the pipeline generation 510 is not a one-time occurrence, but takes place in tandem with pipeline execution 520. When the pipeline relates to the development of a significant project, the pipeline may be executed over the course of months or years. During this time, as new information arises and the project's needs change, the process of pipeline generation 510 may be performed on a continuous or periodic basis. When the new pipeline changes, it may be used in pipeline execution 520 and the old pipeline may be discarded or archived. Thus, the pipeline generation 510 may be performed concurrent with the pipeline execution 520.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

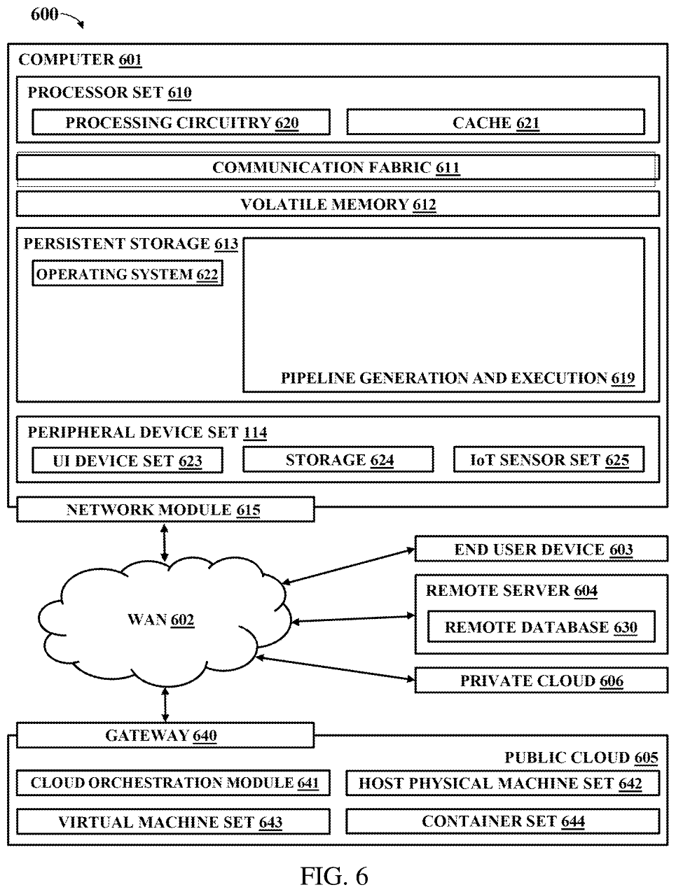

Referring now to FIG. 6, a block diagram of a computing environment is shown. Computing environment 600 contains an example of an environment for the execution of at least some of the computer code involved in performing the inventive methods, such as pipeline generation and execution 619. In addition to block 619, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 619, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible.

Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 619 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 619 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices.

Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Having described preferred embodiments of system development incorporating ethical context (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for development pipeline generation, comprising:
iteratively generating a development pipeline, including:
determining an ethical concern relating to a development pipeline;
identifying a constraint that mitigates the ethical concern; and
adding the constraint to the development pipeline; and
executing the development pipeline concurrent with the iterative generating.

2. The method of claim 1, wherein the development pipeline is a DevOps pipeline script and the constraint is an entry in the DevOps pipeline script that performs a check to ensure the ethical concern is not triggered.

3. The method of claim 2, wherein the DevOps pipeline script further includes instructions to build and deploy a project.

4. The method of claim 1, wherein determining the ethical concern includes a new ethical concern that was not known at initial execution of the development pipeline.

5. The method of claim 4, wherein executing the development pipeline includes executing a new development pipeline responsive to adding the constraint for the new ethical concern.

6. The method of claim 1, wherein the development pipeline develops and deploys a machine learning model.

7. The method of claim 6, wherein the ethical concern is one of bias in training data for the machine learning model.

8. The method of claim 7, wherein the constraint includes bias mitigation during one of pre-processing, training, and post-processing.

9. The method of claim 1, wherein determining the ethical concern includes identifying changes in contextual information relating to the pipeline from one or more artifacts.

10. The method of claim 1, wherein identifying the constraint includes looking up the ethical concern in a database to select a predetermined constraint associated with the ethical concern that mitigates the ethical concern.

11. A computer-implemented method for DevOps pipeline generation, comprising:
iteratively updating a DevOps pipeline script that includes instructions to build and deploy a machine learning model, including:
determining a new ethical concern relating to a bias in training data for the machine learning model that was not known at initial execution of the DevOps pipeline script;
identifying a constraint that mitigates the new ethical concern; and
adding the constraint as an entry in the DevOps pipeline script that performs a check to ensure the new ethical concern is not triggered; and
executing the updated DevOps pipeline script concurrent with the iterative generating.

12. The method of claim 11, wherein the constraint includes bias mitigation during one of pre-processing, training, and post-processing.

13. The method of claim 11, wherein determining the ethical concern includes identifying changes in contextual information relating to the DevOps pipeline script.

14. A computer program product for development pipeline generation, the computer program product comprising a computer readable storage medium having program instructions embodied therewith, the program instructions executable by a hardware processor to cause the hardware processor to:
iteratively generate a development pipeline including:
determine an ethical concern relating to a development pipeline;
identify a constraint that mitigates the ethical concern; and
add the constraint to the development pipeline; and
execute the development pipeline concurrent with the iterative generation.

15. A system for development pipeline generation, comprising:
a hardware processor; and
a memory that stores a computer program which, when executed by the hardware processor, causes the hardware processor to:
iteratively generate a development pipeline, including:
determine an ethical concern relating to a development pipeline;
identify a constraint that mitigates the ethical concern; and
add the constraint to the development pipeline; and
execute the development pipeline concurrent with the iterative generation.

16. The system of claim 15, wherein the development pipeline is a DevOps pipeline script and the constraint is an entry in the DevOps pipeline script that performs a check to ensure the ethical concern is not triggered.

17. The system of claim 16, wherein the DevOps pipeline script further includes instructions to build and deploy a project.

18. The system of claim 17, wherein the ethical concern is a new ethical concern that was not known at initial execution of the development pipeline.

19. The system of claim 18, wherein the computer program further causes the hardware processor to execute a new development pipeline responsive to adding the constraint for the new ethical concern.

20. The system of claim 15, wherein the development pipeline develops and deploys a machine learning model.

21. The system of claim 20, wherein the ethical concern is one of bias in training data for the machine learning model.

22. The system of claim 21, wherein the constraint includes bias mitigation during one of pre-processing, training, and post-processing.

23. The system of claim 15, wherein the computer program further causes the hardware processor to identify changes in contextual information relating to the development pipeline from one or more artifacts.

24. A system for development pipeline generation, comprising:
a hardware processor; and
a memory that stores a computer program which, when executed by the hardware processor, causes the hardware processor to:
iteratively update a DevOps pipeline script that includes instructions to build and deploy a machine learning model, including:
determine a new ethical concern relating to a bias in training data for the machine learning model that was not known at initial execution of the DevOps pipeline script;
identify a constraint that mitigates the new ethical concern; and
add the constraint as an entry in the DevOps pipeline script that performs a check to ensure the new ethical concern is not triggered; and
execute the updated DevOps pipeline script concurrent with the iterative generation.

25. The system of claim 24, wherein the constraint includes bias mitigation during one of pre-processing, training, and post-processing.
